(19) United States
(12) Patent Application Publication
(10) Pub. No.: US 2008/0098381 A1
(43) Pub. Date: Apr. 24, 2008

(54) SYSTEMS AND METHODS FOR FIRMWARE UPDATE IN A DATA PROCESSING DEVICE

(75) Inventor: Chun Hsueh Lin, Pingtung County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/696,106

(22) Filed: Apr. 3, 2007

(30) Foreign Application Priority Data
Apr. 14, 2006 (TW) TW95113321

(51) Int. Cl. G06F 9/44

(52) U.S. Cl. 717/168

(57) ABSTRACT

A firmware update method for a data processing device is provided. The data processing device comprises a MBR (master boot record) which targets an OS (operating system) loader of a first OS, and boots the data processing device in the first OS. A virtual disc comprising a loading module, a backup record, and at least one firmware update code is generated, in which the loading module is an OS loader of a second OS. The content of the MBR is stored in the backup record in the virtual disc and the MBR is modified to target a disc address of the virtual disc. The data processing device is rebooted and the MBR is executed to execute the virtual disc targeted by MBR, the data processing device thereby booting in the second OS. The MBR is restored to target the OS loader of the first OS using the backup record in the virtual disc. The firmware update code in the virtual disc is executed. The data processing device is rebooted in the first OS in response to the OS loader targeted by the MBR.

### BACKGROUND OF THE INVENTION

1. Field of the Invention

The invention relates to methods and systems for updating code, and in particular, to methods and systems capable of updating code and automatically switching between different bit-size OS (operating system) environments.

2. Description of the Related Art

Windows OS is widely used in data processing devices such as PC (personal computer). The user interface of the Windows OS is user-friendly for editing, image processing, and multimedia. When an execution code is not compatible with Windows OS, however, the device must be manually switched to an OS with which the execution code is compatible. For example, a firmware update, such as a BIOS (basic input-output system) update, is solely executable in DOS (Disk Operating System). To complete the BIOS update operation, a device must be rebooted from the Windows OS, booted in DOS to execute the update using removable media, and, after the update, rebooted back to the original OS. This process is complicated, and operational errors are easily generated.

### BRIEF SUMMARY OF THE INVENTION

A detailed description is given in the following embodiments with reference to the accompanying drawings.

The invention provides methods and systems for code and firmware updates allowing simple migration between different bit-sized OSs.

An exemplary embodiment of a method is provided for a data processing device comprising a MBR. The MBR targets an OS loader of a first OS, and boots the data processing device in the first OS. A virtual disc comprising a loading module, a backup record, and at least one update code is generated, in which the loading module is an OS loader for a second OS. The MBR is modified to target the address of the virtual disc. The data processing device is rebooted. The MBR executes the loading module in the virtual disc targeted by the MBR, loading the second OS onto the data processing device. The MBR is then modified to re-target the OS loader of the first OS. The update code in the virtual disc is executed. The data processing device is rebooted and loaded in the first OS according to the OS loader targeted by the MBR.

The invention also provides a system for a data processing device that comprises a MBR to execute code update. The data processing device comprises at least one disc comprising a first disc block having a first disc address and a second disc block having a second disc address. The system comprises at least one virtual disc comprising a loading module, a backup record and at least one update code. The loading module, which is an OS loader of a second OS, is set in the second disc block at the second disc address. The MBR is stored in the backup record in the virtual disc. The data processing device is rebooted and the MBR is executed to execute the virtual disc targeted by the MBR, thereby loading the data processing device to the second OS. The data processing device is rebooted and returns to the first OS after the virtual disc is executed.

The invention also provides an update method for a data processing device that comprises a MBR to update firmware. The MBR targets an OS loader of a first OS, and boots the data processing device in the first OS. A virtual disc comprising a loading module, a backup record, and at least one firmware update code is generated, in which the loading module is a loader of a second OS. The content of the MBR is stored in the backup record in the virtual disc and modified to target a disc address of the virtual disc. The data processing device is rebooted and the MBR is executed to execute the virtual disc targeted by the MBR, thereby loading the data processing device in the second OS. The MBR is restored to the OS loader of the first OS using the backup record in the virtual disc. The firmware update code in the virtual disc is executed. The data processing device is rebooted in the first OS in response to the OS loader targeted by the MBR.

### BRIEF DESCRIPTION OF THE DRAWINGS

The invention can be more fully understood by reading the subsequent detailed description and examples with references made to the accompanying drawings, wherein:

FIG. 1 is a flowchart of a conventional boot method for a data processing device;

FIG. 2 is a schematic illustration of a conventional MBR;

FIG. 3A is a schematic illustration of a data processing device according to an embodiment of the invention;

FIG. 3B is a schematic illustration of the disc blocks according to an embodiment of the invention;

FIG. 3C is a schematic illustration of a virtual disc V according to an embodiment of the invention;

FIG. 4 is a flowchart of a software execution method according to an embodiment of the invention; and

FIG. 5 is a flowchart of a firmware update method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

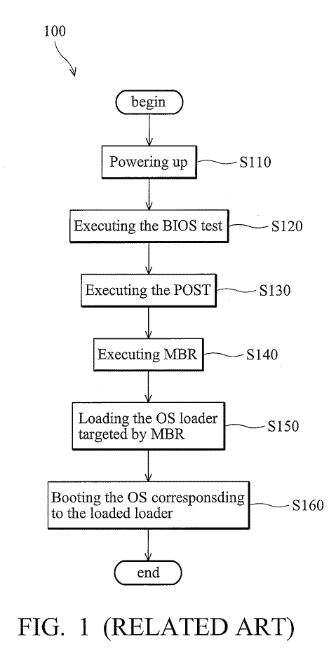

FIG. 1 is a flowchart 100 of a conventional boot method for a data processing device. First, in step S110, a power supply unit is turned on while the data processing device starts booting. In step S120, a CPU (central control unit) in the data processing device then executes a BIOS test. After the BIOS test is passed, in step S130, a POST (power on self test) is executed. After the POST is passed, in step S140, each disc device in the data processing device is searched according to the order set in a BIOS configuration, to read a master boot record (MBR). The master boot record is an important boot sector, usually residing on the beginning of the disc addresses. For example, the MBR may reside on the first sector of the disc.

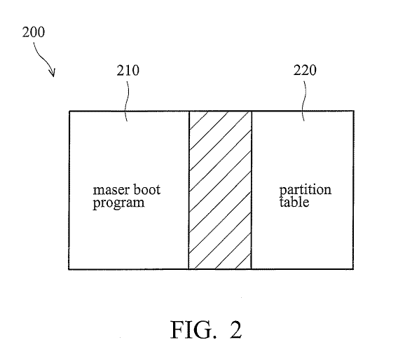

FIG. 2 is a schematic illustration of a conventional MBR 200 including a master boot program 210 and a partition table 220. The master boot program 210 has a pointer targeting an OS loader, defining which OS should be loaded for the data processing device and where to load it during booting. In step S150, the OS loader targeted by the MBR is loaded into the processing device after the BIOS test is successfully passed. In step 160, the OS targeted by the OS loader is loaded and the data processing device booted into the OS. If the data processing device attempts to switch to another OS, it has to load another corresponding OS loader.

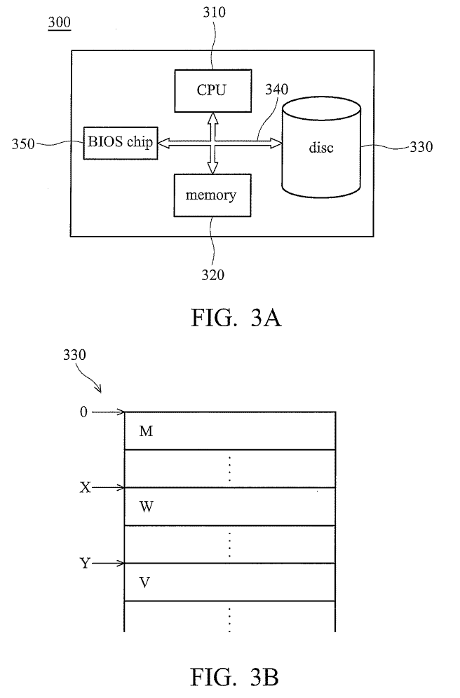

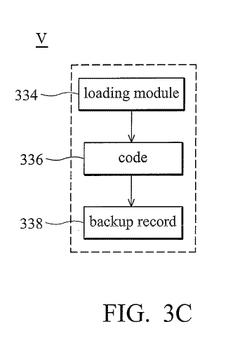

FIG. 3A is a schematic illustration of a data processing device 300 according to an embodiment of the invention. The data processing device 300 includes at least one CPU 130, one memory unit 320, one disc 330, one bus 340 and one BIOS chip 350. Other components in the data processing device 300, such as image controlling unit, audio controlling unit, etc., are well known in the art and thus are omitted herefrom for simplification. The CPU 310, the memory unit 320, the disc 330 and the BIOS chip 350 are coupled together via the bus 340. The disc 330, such as a hard disk, comprises a plurality of disc blocks, each disc block corresponding to a block address. For example, the block address of a disc block may be the sector address of a sector in a disc.

FIG. 3B is a schematic illustration of disc blocks according to an embodiment of the invention. As shown, a MBR M is in the disc block at block address 0, the OS loader of an OS is in the disc block at disc address X, and a virtual disc is in the disc block at disc address Y. FIG. 3C is a schematic illustration of a virtual disc V according to an embodiment of the invention. The virtual disc V includes a loading module 334, a code 336 and a backup record 338. The loading module 334, similar to an OS loader, can boot the data processing device in a specific OS. It is understood that, for example, the loading module may be the loader for DOS or Windows, respectively. The code 336 may be a BIOS update code, a firmware update code or other update code. The backup record 338 is used to back up the original setting of the MBR and restore the MBR after the data processing device is booted in the OS corresponding to the loading module 334.

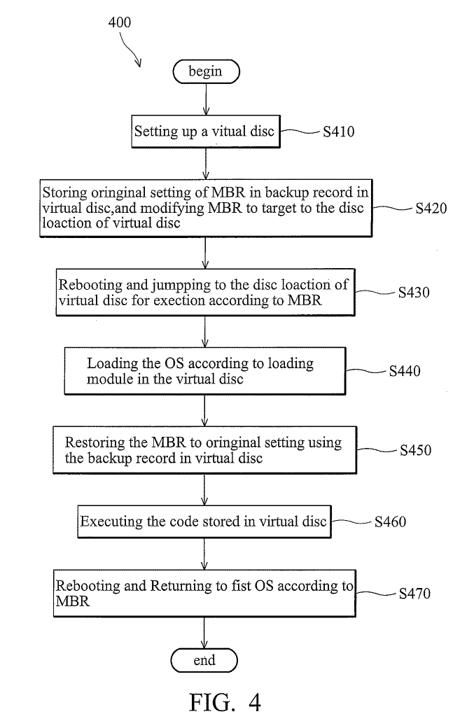

FIG. 4 is a flowchart 400 of a software execution method according to an embodiment of the invention. In step S410, a virtual disc is set up in a disc block at a disc address. The virtual disc comprises a loading module, a backup record and at least one code set, as shown in FIG. 3C. Accordingly, in step S420, the content of the MBR, that is, the original setting of the MBR, is copied to the backup record in the virtual disc and the pointer in the MBR, which originally targeted the disc address of the OS loader of an original OS, is modified to target the disc address of the virtual disc. The data processing device is rebooted, after which the modified MBR is executed. As the pointer in the modified MBR targets the disc address of the virtual disc, the data processing device jumps to the disc address of the virtual disc and operates according to the content in the virtual disc, as in step S430. The OS corresponding to the loading module in the virtual disc is then loaded, as shown in step S440. After the processing device is booted in the desired OS, in step S450, the MBR is restored to its original setting using the backup record in the virtual disc. Thus, the pointer in the MBR again targets the original OS loader at disc address X, to ensure that the data processing device can be rebooted in the original OS if a fatal error occurs during code execution. Then, in step S460, the code stored in the virtual disc is executed. When code execution is completed, the data processing device is rebooted again. Because the original setting of the MBR has been restored, the data processing device is booted back to the original OS according to the OS loader targeted by the MBR, as in step S470.

The invention further provides a user interface for selecting and setting code to be executed. It is to be noted that there may be more than one code set stored in the virtual disc. Therefore, a code set to be executed can be selected in the virtual disc through the provided user interface. In some embodiments, the user interface can provide some notifications and display execution, steps, and notices of the selected code set, avoiding improper operation. In some embodiments, the virtual disc may further comprise more than one loading module, each comprising an OS loader corresponding to a specific OS, such that the data processing device can be switched accordingly.

Additionally, code sets in the floppy disk or CD may be converted to image files using conversion software. The converted image files are stored in the virtual disc and executed using software. Related configurations in the original OS need only be set up through the user interface, and the data processing device can execute code sets compatible with different OSs and return to the original OS automatically. In other words, the data processing device can return to the original OS without extra operations or hardware. Because disc partition is unnecessary, this method can be used in various OSs, such as Windows NT or Linux.

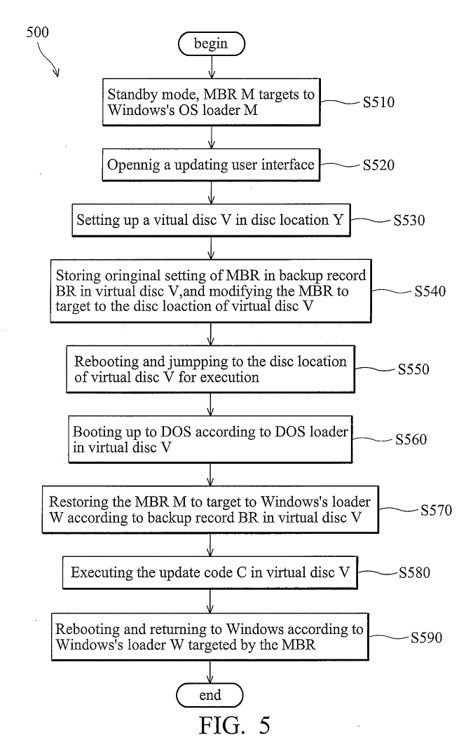

FIG. 5 is a flowchart 500 of a firmware update method according to an embodiment of the invention, allowing execution of firmware updates starting in Windows, moving to DOS, and returning to Windows. In step S510, the data processing device is in standby mode as MBR M targets OS loader W of the Windows OS. A user interface is provided, in step S520, and desired firmware update procedures are configured. In step S530, a virtual disc V is set up in a disc block at a disc address Y. The virtual disc V comprises a DOS loader D, a code set C and a backup record BR. Accordingly, in step S540, original setting of MBR M is stored in the backup record BR in the virtual disc V, and MBR M is modified to target the virtual disc V, such as. the disc address Y. The data processing device reboots, in step S550, jumps to the disc address Y, according to the modified MBR M, and executes the virtual disc V therein, thereby booting the data processing device in DOS according to OS loader D of DOS in virtual disc V (step S560). After the processing device has been booted in DOS, in step S570, MBR M is restored to the original setting, the content of MBR before modification, using the backup record BR in the virtual disc V. Thus, MBR M targets the original OS loader W of the Windows OS. Additionally, in step S580, the firmware update code C stored in the virtual disc V is executed. When the firmware update code C is completed, the data processing device is rebooted again and returned to Windows according to the Windows OS loader W targeted by the MBR, as in step S590. In this embodiment, the configurations in the Windows OS need only be set through the provided user interface, and the data processing device can execute a code under DOS and reboot back to Windows automatically, without requiring extra operations or hardware. Moreover, various firmware update code sets provided by different firmware venders can also be executed, whereby a safe and stable firmware update method is provided.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An update method for a data processing device that comprises a MBR (master boot record), wherein the MBR targets an OS (operating system) loader of a first OS, and boots the data processing device in the first OS, the method comprising:
generating a virtual disc comprising a loading module, a backup record, and at least one firmware update code in which the loading module is an OS loader of a second OS;
storing the content of the MBR in the backup record in the virtual disc and modifying the MBR to target a disc address of the virtual disc;
rebooting the data processing device and executing the MBR to execute the virtual disc;
booting the data processing device in the second OS in response to the loading module in the virtual disc;
restoring the MBR to target the OS loader of the first OS using the backup record in the virtual disc;
executing the firmware update code in the virtual disc; and
rebooting and returning the data processing device to the first OS in response to the OS loader being targeted by the MBR.

2. The method as claimed in claim 1, wherein the first and second OSs are used for different bit-size environments.

3. The method as claimed in claim 2, wherein the first OS is Windows OS.

4. The method as claimed in claim 2, wherein the second OS is DOS (Disk Operating System).

5. The method as claimed in claim 1, wherein the firmware update code is a BIOS (basic input-output system) update code.

6. The method as claimed in claim 5, wherein the firmware update code is an image file.

7. The method as claimed in claim 1, further comprising providing a user interface to set the firmware update code to be executed.

8. A execution method for a data processing device that comprises a MBR (master boot record), wherein the MBR targets an OS (operating system) loader of a first OS, and boots the data processing device in the first OS, the method comprising:
generating a virtual disc comprising a loading module, a backup record, and at least one update code in which the loading module is an OS loader of a second OS;
modifying the MBR to target a disc address of the virtual disc;
rebooting the data processing device;
executing the MBR to execute the loading module in the virtual disc targeted by the MBR, thereby loading the second OS in the data processing device;
modifying the MBR to target the OS loader of the first OS;
executing the update code in the virtual disc;
rebooting the data processing device; and
executing the MBR to return the data processing device back to the first OS according to the OS loader of the first OS targeted by the MBR.

9. The method as claimed in claim 8, wherein MBR modification further comprises storing the content of the MBR such that the MBR is able to re-target the OS loader of the first OS according to the stored MBR after the data processing device is booted in the second OS.

10. The method as claimed in claim 9, wherein the first OS is Windows OS.

11. The method as claimed in claim 9, wherein the second OS is DOS (disk operating system).

12. The method as claimed in claim 8, wherein the first and second OSs are used for different bit-size environments.

13. The method as claimed in claim 8, wherein the update code is a BIOS (basic input-output system) update code.

14. The method as claimed in claim 8, wherein the update code is an image file.

15. The method as claimed in claim 8, further comprising providing a user interface to set the update code to be executed.

16. The method as claimed in claim 8, wherein the virtual disc further comprises a first loading module, a backup record and at least one update code in which the first loading module is an OS loader of a third OS.

17. A system for a data processing device comprising a MBR (master boot record) to execute code update, wherein the data processing device comprises at least one disc comprising a first disc block having a first disc address and a second disc block having a second disc address, the system comprising:
at least one virtual disc, set in the second disc block at the second disc address, comprising:
a loading module, which is an OS loader of a second OS;
at least one update code; and
a backup record, for storing the MBR,
wherein the data processing device is rebooted to the second OS by the content of the virtual disc, and is returned to the first OS after the data in the virtual disc is executed.

18. The system as claimed in claim 17, wherein the first and second OSs are used for different bit-size environments.

19. The system as claimed in claim 17, further comprising a user interface for setting the update code to be executed.

20. The system as claimed in claim 17, wherein the update code is a firmware update code.
